(19) United States
(12) Patent Application Publication
(10) Pub. No.: US 2010/0030551 A1
(43) Pub. Date: Feb. 4, 2010

(54) JARGON TRANSLATION IN AN INSTANT MESSAGING ENVIRONMENT

(76) Inventors: Wendy S. Ark, San Diego, CA (US); Randy S. Johnson, O Fallon, MO (US); Geetika Tandon, Silver Spring, MD (US)

Correspondence Address: HOFFMAN WARNICK LLC, 75 STATE ST, 14 FL, ALBANY, NY, 12207, US

(21) Appl. No.: 12/183,830

(22) Filed: Jul. 31, 2008

(51) Int. Cl. G06J 1/02

(52) U.S. Cl. 704/8

(57) ABSTRACT

A translation system, method and program product for an instant messaging (IM) infrastructure. The system includes a profile look-up system for determining a profile for both a first and a second user engaged in an IM session; a jargon translation profile system for building a translation profile for the first and second users, wherein the translation profile is utilized to identify jargon and associated translations for the first and second users from a jargon database; and display logic for displaying a translation for jargon being shown in an IM display window during the IM session.

### FIELD OF THE INVENTION

This disclosure relates generally to instant messaging (IM), and more particularly to a system and method of indentifying and translating jargon in an IM environment.

### BACKGROUND OF THE INVENTION

Instant messaging (IM) has become a highly utilized form of communication. However, IM users often use jargon, i.e., slang and other phrases that might not be universally understood. For instance, a user in France might not understand a common phrase used by someone in the US. Similarly, a user in one corporate division might not understand jargon used by another user in a different division. Likewise, someone with one skill set (e.g., a technician) might not understand a phrase used by someone with a different skill set (e.g., a lawyer). Accordingly, a need exists to allow different IM users having different backgrounds to communicate more effectively.

### SUMMARY OF THE INVENTION

The present invention relates to a system, method and program product for identifying and translating jargon among two or more users engaged in instant messaging (IM) sessions based on user profiles. In a first embodiment, there is a translation system for an instant messaging (IM) infrastructure, comprising: a profile look-up system for determining a profile for both a first and a second user engaged in an IM session; a jargon translation profile system for building a translation profile for the first and second users, wherein the translation profile is utilized to identify jargon and associated translations for the first and second users from a jargon database; and display logic for displaying a translation for jargon being shown in an IM display window during the IM session.

In a second embodiment, there is a computer readable medium having a computer program product stored thereon for translating jargon in an instant messaging (IM) infrastructure, comprising: program code for determining a profile for both a first and a second user engaged in an IM session; program code for building a translation profile for the first and second users, wherein the translation profile is utilized to identify jargon and associated translations for the first and second users from a jargon database; and program code for displaying a translation for jargon being shown in an IM display window during the IM session.

In a third embodiment, there is a method for translating jargon in an instant messaging (IM) infrastructure, comprising: determining a profile for both a first and a second user engaged in an IM session; building a translation profile for the first and second users, wherein the translation profile is utilized to identify jargon and associated translations for the first and second users from a jargon database; and displaying a translation for jargon being shown in an IM display window during the IM session.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a computer system having translation system in accordance with an embodiment of the present invention.

FIG. 2 depicts an IM interface showing a translation result in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

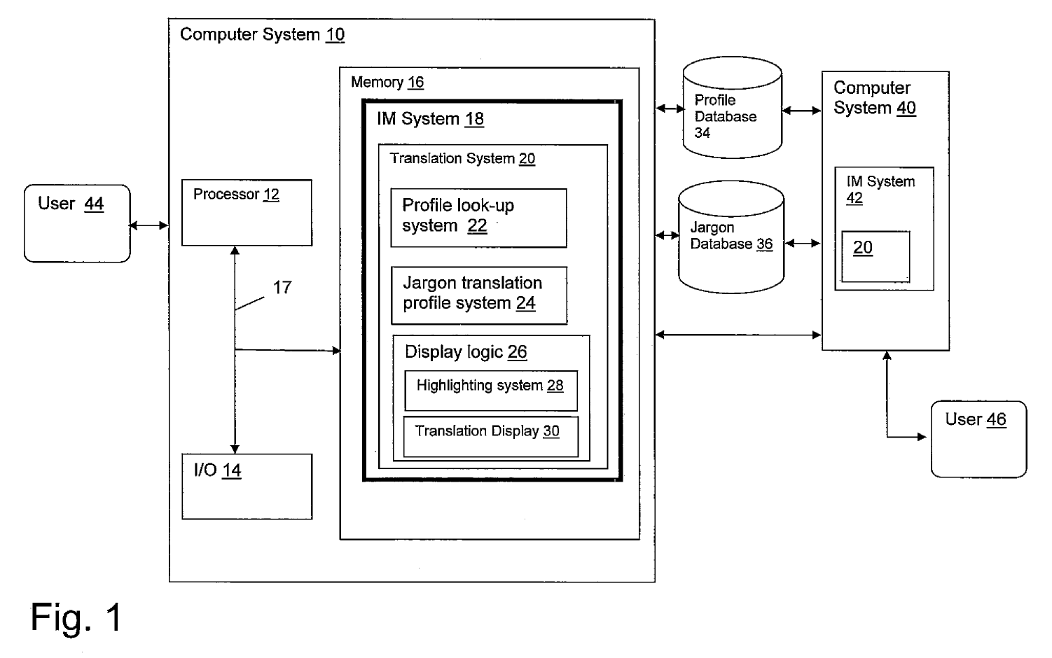

Referring to FIG. 1, a computer system 10 is shown having an instant messaging (IM) system 18 which provides an IM infrastructure for communicating with other IM systems 42 via a network. For the purpose of this disclosure, the term instant messaging includes all forms of high speed text-base messaging (e.g., chatting, IM, text messaging, etc.). In this example, user 44 at computer system 10 is engaged in an IM session via IM system 18 with user 46 at a remote computer system 40. Note however that features described herein with regard to IM system 18 are applicable to situations in which more than two users are engaged in a chat session.

IM system 18 includes a translation system 20 for identifying and translating jargon communicated via IM system 18. (Computer system 40 includes a compatible IM system 42.) For the purpose of this disclosure, “jargon” comprises any word, character string, or phrase that may have ambiguous, unknown, alternative or different meanings among users. Translation system 20 may be implemented as a plug-in, be integrated in the IM system 18, or in any other manner. When a first user 44 enters text to be sent to a second user 46, translation system 20 identifies any jargon and provides a translation based on the profiles of the users 44, 46. Note that IM system 18 may translate incoming (as well as outgoing) messages.

When the first user 44 composes a message, profile look-up system 22 performs a profile lookup for both users 44, 46 from profile database 34. Profile database 34 may be implemented in any fashion, e.g., in a centralized location, distributed across a network, locally on one or more computer systems 10, 40, in a cache, etc. In one illustrative embodiment, profile look-up system 22 can obtain user profiles directly from the IM systems 18, 42 engaged in an IM session. Regardless, a profile of each user 44, 46 is obtained. Each profile includes one or more attributes about the given user. Any type of attributes may be used to form a profile. For example, there may be: company attributes such as name, geography, native language, skills, business unit, job role/description, projects, teams, etc; professional attributes, such as geography, education, skills, years in industry, etc.; social network attributes such as groups, events, friends, networks, interests, etc; etc.

Once the two profiles are retrieved, jargon translation profile system 24 builds a translation profile for the users 44, 46. The translation profile may be built dynamically for each message, be built and saved for a current IM session, or be stored (e.g., in a cache) for user pairs. Once built, the translation profile can be mapped to the jargon database 36 to identify any jargon that should be translated. Specifically, character strings, words, phrases, etc., can be examined as they are being typed into an IM interface against the jargon database based on the translation profile. Thus, because different user pairs will have different translation profiles, a term may be considered “jargon” for a first pair of users, but not for a second pair of users. Moreover, jargon may have a first translation for a first pair of users and a second translation for a second pair of users. Additional factors such as context can be used to determine the proper translation. For instance, textual analytics could analyze ongoing messages between users to determine a context, such as a skill level of users. The determined context could then be used to enhance the translation profile of the two users. Moreover, historical analysis could be utilized to, for example, flag past usages of jargon so that translations are only presented once or every so often.

Display logic 26 is utilized to alter the message display for either or both of the sending and receiving users 44, 46. A highlighting system 28 may be utilized to highlight a character string, word or phrase identified as jargon. Highlighting may be shown in either or both the receiving and sending user's IM display window. Highlighting may include any type of indicator that can be presented in an IM display window, e.g., bolding, shadowing, italics, color change, etc.

Translation display 30 causes the translation to be displayed (or made available for display) for the user when jargon is typed in the display window. The translation may be displayed in any manner. For example, it may appear in a text box, appear via a mouse over, appear via a keystroke or voice command, flash, appear in place of the jargon, etc. User controls may be provided to alter the settings of the highlighting and translations.

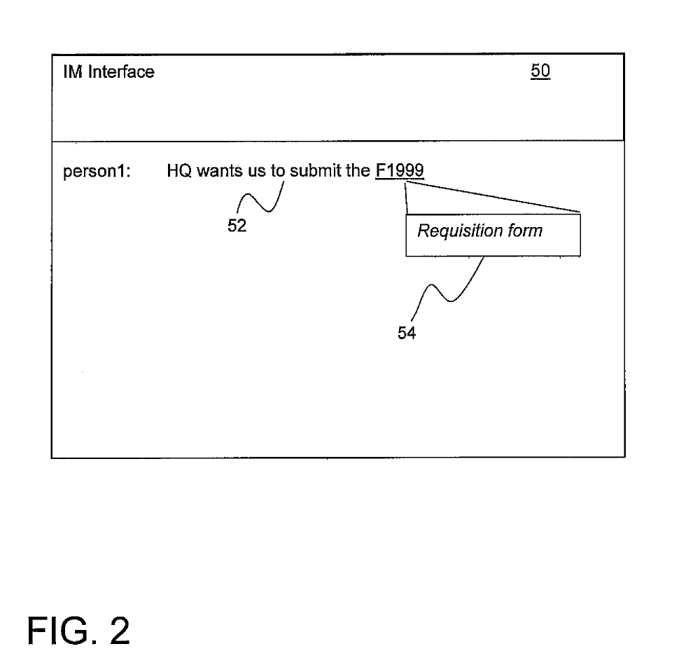

Referring now to FIG. 2, an IM interface 50 is shown with a string of text 52 typed in the display window. In this case, the character string F1999 is highlighted as containing jargon. In this embodiment, a text box 54 is displayed containing the translation. In this example, the string “F1999” has been translation into “Requisition form.”

Referring again to FIG. 1, it is understood that computer system 10 may be implemented as any type of computing infrastructure. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of landline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It is understood that in addition to being implemented as a system and method, the features may be provided as a program product (such as a plug-in or a feature pack) stored on a computer-readable medium, which when executed, enables computer system 10 to provide a translation 20 within IM system 18. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 16 and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A translation system for an instant messaging (IM) infrastructure, comprising:
a profile look-up system for determining a profile for both a first and a second user engaged in an IM session;
a jargon translation profile system for building a translation profile for the first and second users, wherein the translation profile is utilized to identify jargon and associated translations for the first and second users from a jargon database; and
display logic for displaying a translation for jargon being shown in an IM display window during the IM session.

2. The translation system of claim 1, further comprising a system for highlighting jargon in the IM display window.

3. The translation system of claim 1, wherein the translation is displayed in a text box, in response to a mouse roll over, or in response to a key stroke.

4. The translation system of claim 1, wherein at least one of the profiles is determined from a profile database.

5. A computer readable medium having a computer program product stored thereon for translating jargon in an instant messaging (IM) infrastructure, comprising:
program code for determining a profile for both a first and a second user engaged in an IM session;
program code for building a translation profile for the first and second users, wherein the translation profile is utilized to identify jargon and associated translations for the first and second users from a jargon database; and
program code for displaying a translation for jargon being shown in an IM display window during the IM session.

6. The computer readable medium of claim 5, further comprising program code for highlighting jargon in the IM display window.

7. The computer readable medium of claim 5, wherein the translation is displayed in a text box, in response to a mouse roll over, or in response to a key stroke.

8. The computer readable medium of claim 5, wherein at least one of the profiles is determined from a profile database.

9. A method for translating jargon in an instant messaging (IM) infrastructure, comprising:
determining a profile for both a first and a second user engaged in an IM session;
building a translation profile for the first and second users, wherein the translation profile is utilized to identify jargon and associated translations for the first and second users from a jargon database; and
displaying a translation for jargon being shown in an IM display window during the IM session.

10. The method of claim 9, further comprising highlighting jargon in the IM display window.

11. The method of claim 9, wherein the translation is displayed in a text box, in response to a mouse roll over, or in response to a key stroke.

12. The method of claim 9, wherein at least one of the profiles is determined from a profile database.
